(19) United States
(12) Patent Application Publication
(10) Pub. No.: US 2006/0199163 A1
(43) Pub. Date: Sep. 7, 2006

(54) Dynamic teaching method

(76) Inventor: Andrea L. Johnson, San Diego, CA (US)

Correspondence Address: DICKSTEIN SHAPIRO MORIN & OSHINSKY LLP, 2101 L Street, NW, Washington, DC, 20037, US

(21) Appl. No.: 11/365,886

(22) Filed: Mar. 2, 2006

Related U.S. Application Data
(60) Provisional application No. 60/658,201, filed on Mar. 4, 2005.
(60) Provisional application No. 60/724,266, filed on Oct. 7, 2005.

(51) Int. Cl. G09B 3/00; G09B 7/00

(52) U.S. Cl. 434/322

(57) ABSTRACT

A computerized course module creation system that assists an instructor in creating a course modules with lessons and test questions that assess user competency of predefined skills. The skill is created by breaking down the skill into component parts. Once created, the skill can be modified and saved for future use in different course modules. Additionally, a course or a course module is saved and can be used by the instructor's students or another instructor's students. Furthermore, a royalty payment for use of a course model can be shared by a combination of the creator the course module, an educational institutional hosting the creation of the course model, and an instructor teaching a class utilizing the course module.

This application claims priority to U.S. Provisional Patent application No. 60/658,201 filed Mar. 4, 2005, and U.S. Provisional Patent application No. 60/724,266 filed Oct. 7, 2005, both applications are incorporated herein by reference in their entirety

### FIELD OF THE INVENTION

This relates to the field of educational methods, and more specifically, to a software tool to create an electronic teaching assessment tool.

### BACKGROUND OF THE INVENTION

Teaching methods for many years have remained the same. Information is imparted by the instructor through lecture or discussion, and the student is tested on his or her understanding of that information at the end. Studies show that these teaching methods tend to be rather passive and linear and do not assure student knowledge or comprehension. Effective learning requires integration of different methodology and assessment at multiple levels, e.g., discussion, small group exercises, and self-directed learning.

Virtually all educational institutions submit their programs and courses to some form of independent accreditation body to assure students that there are minimum standards of content. Accreditation impacts directly on the ability of an educational institution to attract students for admission, job placement, and institutional ranking. Accreditation bodies now require that educational institutions not only identify student learning goals and objectives, but also be able to measure and verify student learning of those objectives through assessment.

A learning goal is preferably what the instructor hopes the student will achieve in the course. Preferably a learning outcome is the specific knowledge or skill that a student achieves from being part of a learning experience. It is also preferably understood that a skill is the ability to demonstrate that a student can perform a given task to achieve an intended outcome such as critical thinking or creative problem solving, or to learn an abstract idea.

Traditional assessment methods used by educational institutions rely upon surveys and questionnaires of students' self-reflection of whether and how much they learned, as well as standardized tests,. There have not been effective tools to objectively measure student learning from a statistical basis, or to enable the instructor to evaluate the effectiveness of his or her assessment methods.

Historically, instructors have not been trained on how to identify learning goals and outcomes or trained on how to develop effective questions to measure student learning. In developing a course, most instructors focus on coverage of the material using the textbook as an outline for developing the course syllabus, or rely upon standards given to them by the state regulatory body. Rarely do instructors begin their planning by focusing on their goals for student learning or targeting identifiable skills. This is preferably referred to as uncoverage, i.e. guided inquiry into abstract ideas by making them more accessible and meaningful. Moreover, instructors often do not adequately account for, predict, or respond to misconceptions, misunderstandings, and unexpected difficulties in student comprehension of materials.

Traditional methods of assessment used in most classes occur at the end of the term, i.e., final exams or paper. These methods do not effectively evaluate a student's competency of subject matter and/or skills or facilitate student learning because feedback from the instructor cannot be integrated back into the learning process. It merely sorts and ranks students. There is no diagnostic tool to enable instructors to target specific weaknesses as part of their instruction, provide remediation, or enable students to incorporate what they have learned to enhance student performance. As a result, traditional methods alone do not facilitate knowledge or understanding, where knowledge generally refers to the identification of facts, inferences, and nuances of a concept.

Studies have shown that formative assessment, which is a process of assessment that allows students to integrate instructor feedback into the learning process, is a generally preferred method of measuring understanding. In a generally preferred approach, understanding involves the ability to demonstrate sophisticated insights and abilities, reflected in varied performances and context, which can be measured through objective assessment tools.

Formative assessment includes lesson examination, capstone projects, case analysis, self-check activities, pre and post-tests, objective tests and essay examinations. Particularly in large classrooms, it has been impractical to employ a variety of formative assessment measurements because instructors lack the time and inclination to grade them and still teach the class. Instructors need to receive an incentive to undertake the work necessary to create effective assessment measurements.

Today's educational classrooms increasingly rely upon technology to expand the boundaries of time and space so that students can learn any time and anywhere. The Internet provides a relatively inexpensive and fast service, for the delivery of content, collaboration, and accessibility to new teaching methods. To use technology effectively for learning, the learning process must be dynamic, active, and interactive. Instructors should identify desired results, determine acceptable evidence of performance, and plan learning experiences and instruction. Courses should be developed based upon desired results, goals or standards and then build the course from evidence of learning called for by conventional educational standards.

It would be desirable to have an electronic authoring tool that when an Instructor has identified a desired skill to be learned by students, the tool would guide an Instructor through the identification and description of the elements of the skill.

It would also be desirable to have an electronic authoring tool for course development that helps an instructor and educational institution identify, track, measure and report on student learning in course modules without special knowledge of computers or technology, or the need to manually grade exams, quizzes, or other types of tests. Additionally, it would be desirable that the authoring tool can guide the Instructor through elements of the course, where a course may include several different sections and several questions.

It further would be desirable to enable instructors to evaluate the effectiveness of their assessment methods, individually or collectively, and receive compensation in the form of royalties for developing course modules.

### BRIEF SUMMARY OF THE INVENTION

An authoring tool is provided that helps a course instructor develop lessons and questions that target relevant skills identified by the instructor. This authoring tool is available electronically through the Internet so that where the instructor and student interact electronically, a student's learning can be assessed. A first aspect of the authoring tool includes a Skills Wizard that guides the course instructor through the creation of a skill by deconstructing the skill into elements of the skill. A second aspect of the authoring tool includes a Questions Wizard that guides a course instructor through the creation of questions for a course module using a skill that has been previously deconstructed.

In another aspect of the invention, a method for providing financial incentives for creating and/or sharing course modules is provided. By providing a royalty system to both an author of a course module and to the educational institution hosting the course, there is provided an incentive to use and to share course modules.

### BRIEF DESCRIPTION OF THE DRAWINGS

These and other features and advantages of the invention will be more readily understood from the following detailed description of the invention which is provided in connection with the accompanying drawings, in which:

FIG. 1 is a diagram depicting logic partitions of a electronic workbooks system in accordance with an exemplary embodiment of the invention;

FIG. 2 shows a logical representation of elements of a course in accordance with an exemplary embodiment of the invention;

FIG. 3 shows a logical representation of Wizards included as part of an exemplary embodiment of the invention;

FIG. 4 is a logical representation of elements of a skill in accordance with an exemplary embodiment of the invention;

FIG. 5 is a flow chart depicting the steps following in creating a new skill using the Skills Wizard;

FIG. 6 is a flow chart depicting the inclusion of a branched question;

FIG. 7 is a flow chart depicting a program flow with a branching aspect;

FIG. 8 is an author system employed in a computer network system according an exemplary embodiment of the invention;

FIG. 9 depicts an author system employed in a computer network system in another aspect of an exemplary embodiment of the invention;

FIG. 10 depicts a logical schematic of an author system according an exemplary embodiment of the invention;

FIG. 11 is chart depicting an interaction of parties according to an exemplary embodiment of the invention; and

FIG. 12 is a table depicting the sharing of intellectual property rights according to an exemplary embodiment of the invention.

### DETAILED DESCRIPTION OF THE INVENTION

In the following detailed description, reference is made to the accompanying drawings, which form a part hereof, and in which is shown by way of illustration specific exemplary embodiments of the invention. These embodiments are described in sufficient detail to enable those of ordinary skill in the art to make and use the invention, and it is to be understood that structural, logical, or other changes may be made to the specific embodiments disclosed without departing from the spirit and scope of the present invention.

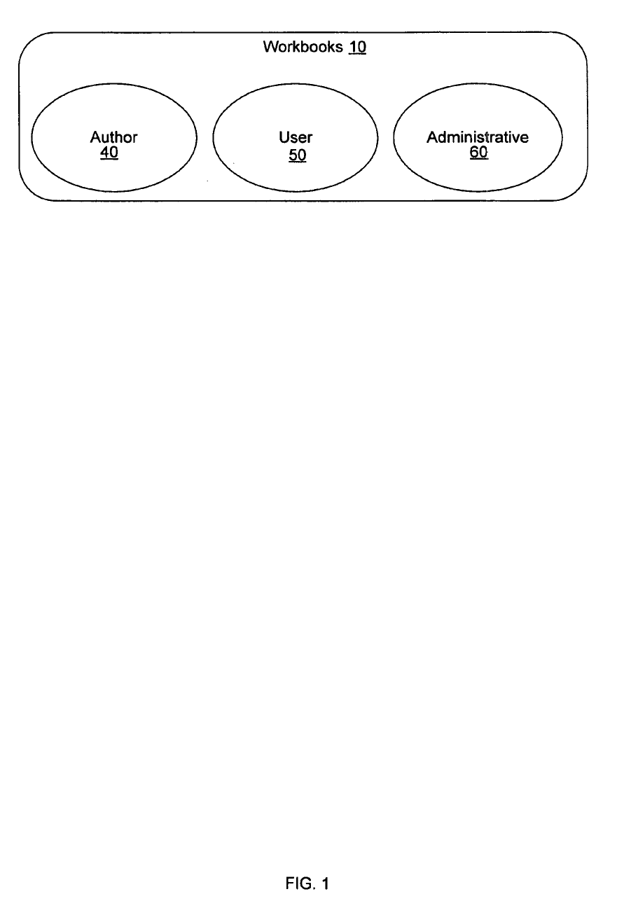

In an exemplary embodiment of the invention, a dynamic teaching method provides electronic mechanisms to help effectuate educational goals identified by an instructor. FIG. 1 shows a logical representation of an electronic computer workbooks system 10 that incorporates the dynamic teaching method according to an exemplary embodiment of the invention. Electronic workbooks 10 is a web-based course development platform that consists of three tools: Author tool 40, User tool 50, and Administrative tool 60. Each of the three tools is an independent software program that is executed independent from the other tools. The tools are interdependent in that a course module must be authored before it can be accessed, graded, or customized. A tool may create, use and modify a course module or testing results of a course module that is created, used or modified by a different tool. Although described with reference to being web-based, the invention is not so limited. Furthermore, each tool may reside on a separate computer system. For example, an Author tool 40 may reside on a work station and its resulting data is provided to a website where a User tool 50 resides and is executed from. Additionally, questions created in an author tool 40 maybe exported for use in other programs or in hard copy form.

In a preferred embodiment, the Author tool 40 is the part of the Electronic Workbooks 10 where an Instructor creates and modifies a course, e.g., a module, a part, a lesson, or a question, as explained more fully below. In a preferred embodiment, the User tool 50 is the part of the electronic workbooks 10 where a student accesses and utilizes a previously created course module. The Administrative Tool 60 is the part of the electronic workbooks 10 used for customizing a course module and generating reports.

The Author tool 40 of FIG. 1 is an authoring tool that assists a course instructor in creating a course by guiding an instructor through steps of inputting information in response to a series of queries or prompts that result in a creation of an electronic course. A course may have a plurality of modules, each module may have a plurality of parts, each part may have a plurality of lessons, and each lesson may have a plurality of questions. In a preferred embodiment, a lesson requires the instructor to identify a particular skill to be tested as part of the course module, where the skill is deconstructed into component parts. Tests can be created for a lesson from issues identified by the instructor for a course module. The author tool 40 can be downloaded onto different computers, course modules created and then uploaded to a server, e.g., or a server of the educational institution associated with the instructor.

The User tool 50 is preferably accessed by a student user with a user name and password that is predefined by an electronic Workbooks system administrator and relates to a specific course module. The user needs a separate user name and password for each course module selected by an instructor. The user is prompted to complete a profile page that requests predefined information requested from the instructor. The user is then directed to a table of contents to select the part and lesson. Users can go through the parts and lessons in any order but must access the questions associated with the lessons in successive order. As part of the student's access to a course module, the student may opt to attend previously created course module and or take a test from that course module or view her results from a test from a course module that she has previously taken.

The Administrative tool 60 of FIG. 1 is preferably accessed with a user name and password that is predefined by a electronic workbooks system administrator. The Administrative Tool 60 is primarily used by instructors for customizing courses and generating reports of information from tests taken on the courses.

In an embodiment of the invention, the Administrative Tool 60 also establishes parameters for usage by instructors for security purposes. In this aspect, the Administrative tool 60 includes a parameter for a predetermined number of program starts, i.e., separate accesses to the computer program, and/or predetermined working periods where an instructor/administrator can access the Administrative Tool 60. Upon initial startup, the Administrative tool 60 asks for the user name and password and then connects to the Administrative tool 60 and automatically downloads a pre-approved license key. In a preferred embodiment, there is a limit on the number of computers to which the Administrative tool 60 software can be downloaded, e.g., at a an educational institution, there are unlimited numbers of instructors who can use the authoring tool 40 using their respective unique identifications that are provided as part of the administration of the workbook system. The identification of the instructor is also used to determine the instructor's entitlement to royalties, as discussed more fully below. In an exemplary embodiment, once the electronic workbooks program is initiated faculty members will participate in on-line or live training. However, it is also possible for the Administrative tool 60 to be downloaded on a local server and then accessed by anyone with access to the server.

In a preferred embodiment, Administrative tool 60 is downloaded onto the hard drive at the local site of the instructor or at the instructor's personal computer. Thus, the Administrative tool 60 uploads and downloads courses, creates user accounts, tracks and reports on student performance.

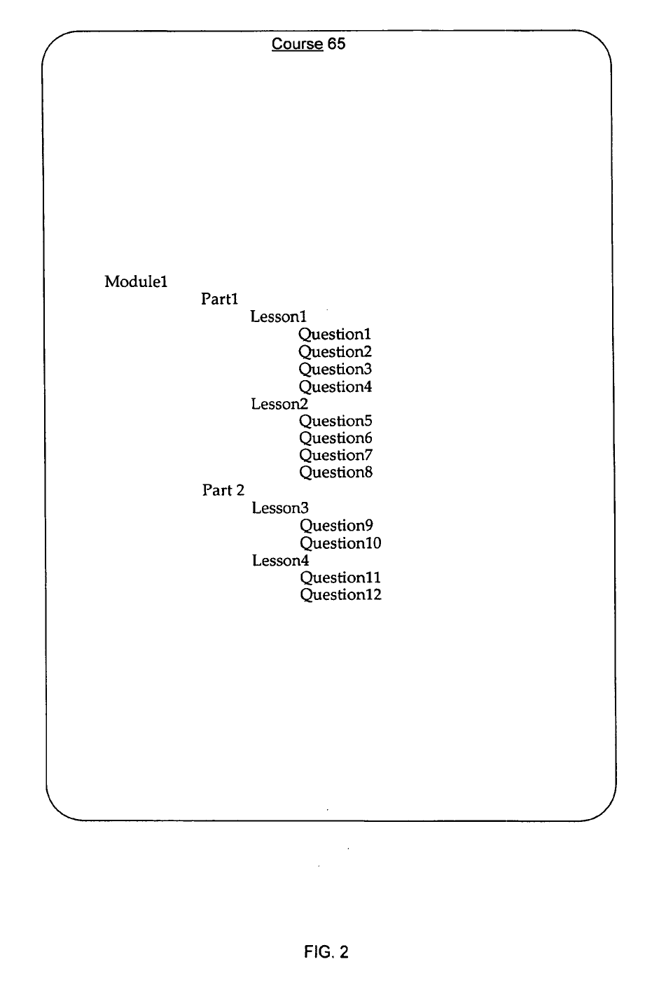

FIG. 2 shows a logical representation of elements of a course 65 in accordance with an exemplary embodiment of the invention. In a preferred embodiment, a course consists of at least one module, which includes at least one part, which includes at least one lesson, which includes at least one question. It is up to an instructor when creating or modifying a course to determine where the respective subdivisions between modules, parts, or lessons will occur as well as determining the number of modules, parts, lessons, and questions. The instructor also decides how the subject matter of the course 65 is subdivided and associated with the modules, parts, and lessons.

In preferred embodiment, an instructor creates and includes a narrative describing the course and subsections of the course, as well as goals thereof. The narrative includes instructions for a student to follow in proceeding through the course. The narrative includes the teachings of the course and is the form of text, videos, or any form of method for communicating information. The narrative may refer to external sources of information, e.g., external readings or assignments. The instructor may also choose to include case studies or examples in furtherance of explanation of the course. For example, the narrative directs the student to read Ulysses and then return to the program to answer questions related to the reading.

In a preferred embodiment, a module covers at least one subject in a course with interrelated parts that usually covers between one-third and one-seventh of the material in that course and focuses on one or more skills. A part covers a subset of the course. A lesson is a component of a course part that targets a specific skill. A skill is defined, as noted further below, and questions are created assessing the components of the skill, where the questions are usually created in a series.

In a preferred embodiment, a course can be represented in a tree-like data-structure, where the course is the root, the modules are the trunk, the parts are the branches, and the lessons are the leaves, and the questions are the veins on the leaf, creating a building block or hierarchical approach. For example, a part in a module is created after the module is created because the module is a higher level element than the part. Further, a lesson in a part is created after the part is created because the part is a higher level element than the lesson. Additionally, a question in a lesson is created after the lesson is created because the lesson is a higher level element than the question. There are no restrictions on the nature or type of data in each level. Additionally, in a preferred embodiment of the invention, creating the course is done in a depth-first approach, where the creation of the course elements is done by proceeding down to the lowest level of a first branch of a tree and then backing-up and then proceeding down the next branch of the tree. In alternative embodiments, the creation of the elements of the course is not so limited and can be done by any approach, for example, the course can be created in a breadth-first approach, where all the elements of a certain level are created before creating element on a next lower level, e.g., creating all of the modules of a course before creating the lessons of the modules.

For example, in the course 65, an instructor decided that the course 65 has one module: module1, where module1 has two parts: part1 and part2, where part1 has two lessons: lesson1, lesson2, and part2 has two lessons: lesson3 and lesson4. Lesson1 has four questions and lesson2 has four questions. Lesson3 has two questions and lesson4 has two questions. Although the elements of the course 65 are labeled sequentially, e.g., lesson1, lesson2, lesson3, lesson4, etc., it is not intended that the different elements are necessarily related nor follow in a sequential flow. Although shown with only one module, a course is not so limited and can have any number of modules.

A student's learning process, and ideally the student's mastery of a course, is also a hierarchical approach: she must master the lower level element, e.g., reading comprehension, before being able to master a higher level element, e.g., applied reasoning. Ideally, each part in a module is self contained and include the lessons necessary to teach one or more concepts of a skill.

One or more instructors can work on separate sections of a same course module and merge the sections. After a course module is created, it is saved automatically. In a preferred embodiment, the instructor uploads the course module to the server. Additionally in another aspect of the invention, the instructor makes the course module available to third parties, e.g., other instructors. After the course module is uploaded to an server and user name and password accounts are set up, students enrolled in a class using the course module can access the course module.

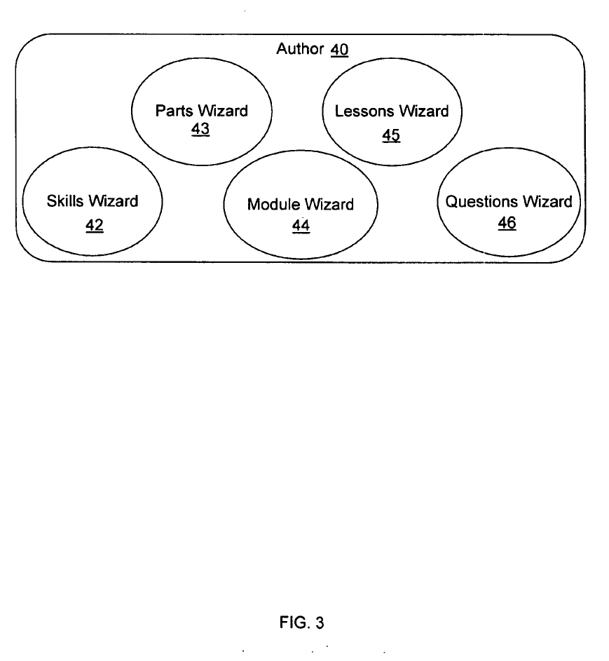

In a preferred embodiment, Author 40 includes five wizards to assist an instructor in the creation and maintenance of a course, as depicted in FIG. 3: a Skills Wizard 42 to assist an instructor in the deconstructing a course skill into component parts, a Parts Wizard 43 to assist an instructor in the creation of the course's lesson parts, a Lesson Wizard 45 to assist an instructor in identifying the course's skill(s) to be assessed and learning outcomes, a Module Wizard 44 to assist an instructor in the creation of the course's table of contents that includes parts and lessons, and a Questions Creator wizard 46 to assist an instructor in the creation of the course's lesson questions. Author 40 also provides manual editing tools (not shown) for the creation, modification, and deletion of modules, lessons, parts, and questions.

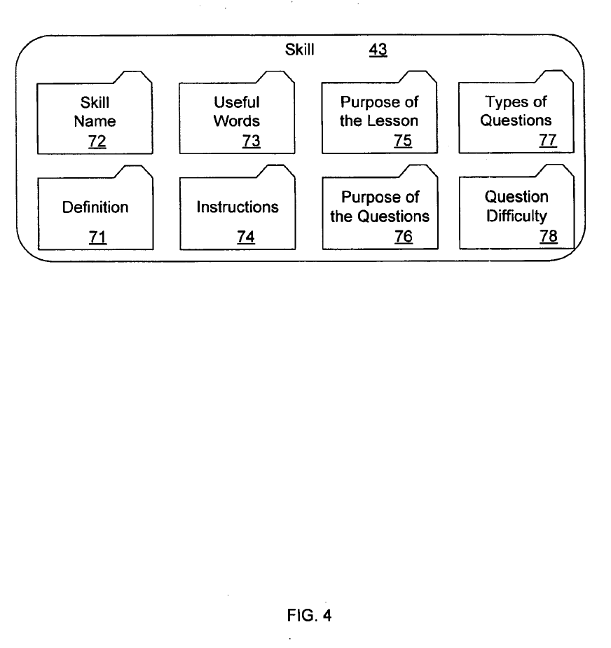

Before a skill can be used to create a lesson, the skill 43, as depicted in FIG. 4, must be created and accessible, having been either previously created by a third party or by the instructor. In a preferred embodiment, teaching a class or a subject requires one or more lessons, each lesson targets a specific skill 43, and a skill 43 cannot be assessed without two or more questions because every skill 43 has multiple component parts. An author can also manually insert questions. In preferred embodiment of the invention, a skill 43 has eight information storage areas, e.g., data fields or elements or folders, as depicted in FIG. 4: the name of the skill, the definition of the skill, useful words (when referring to the skill), instructions about the skill, purpose of the lesson, purpose of the questions, the types of questions that correspond to the skill, and the difficulty of each of the questions for this skill.

In the exemplary embodiment of the invention, Skills Wizard 42 is a program or process that guides an Instructor through the logical sequence of steps of deconstructing a new skill 43. As illustrated in FIG. 4, Skills Wizard 42, populates and formats a skill 43 having eight folders with data, e.g., text and numbers: Skill name 72, Definition 71, Useful Words 73, Instructions 74, Purpose of the Lesson 75, Purpose of the Questions 76, Types of Questions 77, and Question Difficulty 78. The data stored in these folders is variable and may be modified or deleted. A skill 43 can be later modified or deleted by a user using a skill editor, which is a manual editor that permits an Instructor to access and edit the data stored in the folders 72-78.

To use the Skills Wizard 42, in an exemplary embodiment, an instructor selects the Skills Wizard option provided in the Author 40 and follows the instructions as prompted and provides data in response to a response to prompts from the Skills Wizard 42 to populate the eight folders 71-78. The folders 71-78, in a preferred embodiment, refer to a logical representation of data storage, and are not required to be in computer operating system folder. In an exemplary embodiment, an instructor should provide at least information to populate folders 71, 72, 73, and 74. Information for folders 75, 76, 77, and 78 is still desired, and an instructor may provide information for placement in the folders, but is not required to do so. The Skills Wizard 42 guides the instructor through the population of information for the different folders in a pre-defined order. At the processing of data for each folder, the instructor is prompted to enter information for data field(s) of the folder. Once the data is entered into the folders, the new skill appears in a list of Skills available in the author 40 and can be subsequently used and modified by the Instructor during the creation or modification of a course. The instructor also has the ability to cancel the Skills Wizard 42 and return to the author 40.

In a preferred embodiment, the Skills Wizard 42 provides “Tips”, “Help”, and “Instructions” as commonly known to those with skill in the art. The Skills Wizard 42 also provides information for using the Skills Wizard 42 and entering data. Tips and Help explain or give examples of what should be included in each folder.

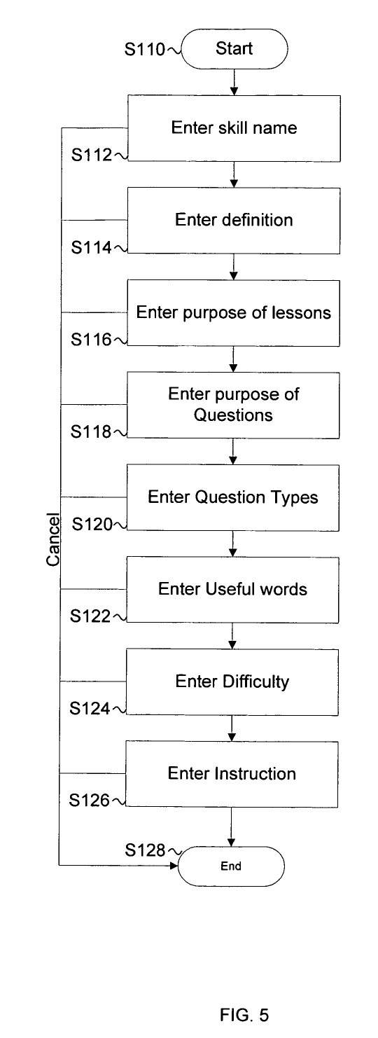

FIG. 5 depicts a flowchart representing the logical flow through the creation of a new Skill 43 as controlled by the Skills Wizard 42 program according to an exemplary embodiment of the invention. In an embodiment of the invention, each folder is previously loaded with instructions that are provided to the Instructor to guide her to describe the information sought. In an alternate embodiment, the instructions provided to the Instructor are stored in the Skills Wizard 42 or some other part of the author 40.

The creation of a skill starts in segment S112 where the Skills Wizard 42 displays for the instructor information for sought for storage in a first folder—the Skill Name folder 72. In this segment, the Skills Wizard 42 prompts the instructor to enter the name of the skill. Information in the Skill Name folder 72 is used to display an instruction welcoming the instructor to the process of creating a new skill. The folder 72 further provides instructions to the instructor. For example, folder 72 may contain information to be conveyed to the Instructor that the Skills Wizard 42 is designed to help the instructor create a new skill, and then draft effective questions related to that skill using a Questions Wizard, described below. The folder 72 provides further information that indicates to the instructor that there are two steps to the creation of a skill: The first step is to define and deconstruct the skill into its component parts. Information from folder 72 also indicates to the instructor the process of creating the skill begins by naming the skill, and indicating that she wants to proceed to the next segment. In response to the prompts, the instructor can enter, for example, “Reading Comprehension” as the skill name for the skill that the Instructor is creating.

If the instructor indicates that she wants to continue with the creation of a Skill, the Skills Wizard 42 sequence continues to segment S114. Otherwise, the Skills Wizard 42 sequence continues to segment S128 where the Skills Wizard ends.

In segment S114, the Skills Wizard 42 displays instructions for providing data for the Definition folder 71. In this segment, the instructor is prompted to define the skill 43. The Skills Wizard 42 displays instructions that indicate that the instructor should define the skill by identifying its component parts. The parts should reflect a process or learning outcome, e.g., “Evaluate” for Critical Thinking, “Apply” for Applied Reasoning, and “Solve” for Creative Problem Solving. The Skills Wizard 42 prompts that the instructor enters data in each component part as a category in the instructions.

For example, for the skill “Reading Comprehension,” the instructor can enter as the definition of the skill:
The ability to digest, assimilate, understand, and distinguish the important points and facts, and the ability to identify any unresolved issues that are raised. Comprehension includes knowledge or the ability to recall previously learned material, and demonstrating an understanding of the meaning of facts by explaining, interpreting, and translating. The key is to recall and explain facts, principles, and steps in sequence.

If the instructor indicates that she want to continue with the creation of a Skill, the Skills Wizard 42 sequence continues to segment S116. Otherwise, the Skills Wizard 42 sequence continues to segment S128 where the Skills Wizard 42 ends.

In segment S116, the Skills Wizard 42 displays instructions for providing data for the Purpose of the Lessons folder 75. In this segment, the instructor is prompted to provide an explanation of the purpose of the lessons. The Skills Wizard 42 indicates that the instructor should specify whether the lessons are intended to provide all of the information needed to answer the questions, or supplement course work already assigned. If the lesson is self-contained, it is advisable that the instructor add additional instructions, e.g., a glossary and resource links for additional explanation. The instructor may also choose to include case studies, video and audio lectures as necessary.

For example, for the skill “Reading Comprehension,” the instructor can enter for the Purpose of the Lessons:
To provide information on the rules, principles, theories and concepts necessary for a basic understanding of material. A minimum of two lessons for each part is suggested, using text, graphic, and/or video.

If the instructor indicates that she wants to continue with the creation of a Skill 43, the Skills Wizard 42 sequence continues to segment S118. Otherwise, the Skills Wizard 42 sequence continues to segment S128 where the Skills Wizard 42 ends.

In segment S118, the Skills Wizard 42 displays instructions for providing data for the Purpose of the Questions folder 76. In this segment, the instructor is prompted to provide an explanation of the purpose of the questions. The Skills Wizard 42 indicates that the instructor should decide the action required to develop a proficiency in that skill using different types of questions and that questions should be grouped in a series or set. The Skills Wizard 42 can additionally indicate that the purpose of most questions is to answer the questions who, what, when, where, why, how, so what, and the practical applications.

For example, for the skill “Reading Comprehension,” the instructor can enter for the Purpose of the Questions:
To answer the questions who, what, when, and where by identifying primary issues, distinguishing important facts and their significance, defining terms and restating basic concepts.

If the instructor indicates that she want to continue with the creation of a Skill 43, the Skills Wizard 42 sequence continues to segment S120. Otherwise, the Skills Wizard 42 sequence continues to segment S128 where the Skills Wizard 42 ends.

In segment S120, the Skills Wizard 42 displays instructions for providing data for the Question Type folder 77. In this segment, the instructor is prompted to indicate the type of the question. The Skills Wizard 42 indicates that there are six types of questions: true/false, multiple choice with single, multiple and branching answers, matching parts and functionality, and short answer questions. Different types of questions are good for measuring different component parts.

For example, for the skill “Reading Comprehension,” the instructor can enter for the Type of the Question:
Focus on Multiple Choice questions with one (MC) or more correct answers (MC 1+), Puzzles (P) with 4-6 clues and answers, including matching parts with functionality, making comparisons, defining terms, and distinguishing important and unimportant facts or issues.
The total number of questions per lesson should include 3-12 Multiple Choice questions, True/False and/or Puzzles with 4-6 clues. Multiple Choice questions with one correct answer should be given 1 min. / question, Multiple Choice questions with one or more correct answers, i.e., check boxes, should be given 2-3 min./question, Puzzles with 4-6 clues should be given 1 min. /clue, and True/False should be given 1 min/clue. Short answer questions with only two sentences should be given 2 minutes. Short essay questions should be given 15 minutes if done individually, or 30 minutes if discussed in a group.

If the instructor indicates that she want to continue with the creation of a Skill43, the Skills Wizard 42 sequence continues to segment S122. Otherwise, the Skills Wizard 42 sequence continues to segment S128 where the Skills Wizard 42 ends.

In segment S122, the Skills Wizard 42 displays instructions for providing data for the Useful Words folder 73. In this segment, the instructor is prompted to indicate words that describe the skill, e.g., buzz words. The Skills Wizard 42 indicates to the instructor to identify key words that can begin a question or identify the action required to answer the question, e.g. describe, identify, apply, solve etc.

For example, for the skill “Reading Comprehension,” the instructor can enter for the Useful words:
Define, list, state, identify, label, name, who, when, where, what, and explain, predict, interpret, infer, summarize, convert, translate, give example.

If the instructor indicates that she want to continue with the creation of a Skill 43, the Skills Wizard 42 sequence continues to segment S124. Otherwise, the Skills Wizard 42 sequence continues to segment S128 where the Skills Wizard 42 ends.

In segment S124, the Skills Wizard 42 displays instructions for providing data for the Enter Difficulty folder 78. In this segment, the instructor is prompted to indicate an explanation of the difficulty of the skill. The Skills Wizard indicates that a series of questions can have varying degrees of difficulty much like building blocks and that questions should be answered in succession and get progressively harder. When the instructor assesses points to questions, the instructor should consider assigned points based upon the level of difficulty of the question.

For example, for the skill “Reading Comprehension,” the instructor can enter for the Enter Difficulty folder:
This skill requires a basic level of difficulty, due to the amount of time allocated and the nature of the answers sought. For example, Multiple Choice questions with multiple answers should be weighted heavier than True/False or Multiple Choice questions with one correct answer. It is presumed that the answers to the questions should be evident from the lessons.
Points should be given for answering the questions within the time allotted to reflect the level of difficulty, and for answering the questions correctly with the minimum number of tries.

If the instructor indicates that she want to continue with the creation of a Skill 43, the Skills Wizard 42 sequence continues to segment 126. Otherwise, the Skills Wizard 42 sequence continues to segment S128 where the Skills Wizard 42 ends.

In segment S126, the Skills Wizard 42 displays instructions for providing data for the Instructions folder 74. In this segment, the instructor is prompted to provide Instructions regarding the components of the skill. The Skills Wizard 42 indicates that the instructor should identify the most critical components of the skill in one to three words and enter them each as a category. In the instruction field for each category, using the key words, the Instructor creates a prompt that will engender a response that reflects a component of the skill. The instructor is guided to enter a prompt in the form of a question as this will appear as the first prompt in the Skills Wizard when, at a later time, an instructor is creating questions that test the competency of that skill. For example, the first component of Reading Comprehension requires the user to distinguish important and unimportant facts. The Category would be “Most Important Issues” and the instruction would use one of the buzz words to prompt the author to “Distinguish” the five most important points. The unimportant facts would the wrong answers.

For example, for the skill “Reading Comprehension,” the instructor can decide that the skill has four components, and enter instructions for the first component “Points”:
Identify up to five important points or principles raised in the lesson. (State in the form of a question using the key words.)

For the second component, Issues, the instructor can enter the following instruction:
Identify up to two important unresolved issues or unknown facts. (State in the form of a question using the key words.)

For the third component, Most Important, the instructor can enter the following instruction:
Identify the most important fact or point raised in the lesson. (State in the form of a question using the key words.)

For the fourth component, Case Study, the instructor can enter the following instruction:
Identify an issue in a case study or hypothetical. (State in the form of a question using the key words.)

If the instructor indicates that the new skill should be saved, then the skill, e.g., “Reading Comprehension,” is saved automatically in the system for future use. The Skills Wizard sequence continues to S128 where the Skills Wizard 42 program ends.

The Questions Wizard 46 (FIG. 3) utilizes the data in the Instructions Folder 74 of the skill 43 selected by the instructor when drafting a set of questions that for a particular skill. This is discussed in further detail below.

Thus, the Skills Wizard 42 guides an instructor through the creation of a new skill by deconstructing the skill into different components of the skill. The new skill can now be used for the creation of questions.

As with the other folders in the created skill, the Instructor can change any of the instructions displayed for deconstructing a skill in the Skills Wizard 42. Modifications are made in a Skill Editor (not shown) and are automatically saved and displayed when the skill is selected during the creations of questions. In an embodiment, questions can be created using a question creator or a questions wizard, discussed more fully below.

In a preferred embodiment, the Skills Wizard Author tool 40 (FIG. 1) includes four predefined skills that can be used by the instructor in the creation of questions: Reading Comprehension, Critical/Analytical Thinking, Applied Reasoning, and Creative Problem Solving. Additional skills, either created by the Instructor or a third party, can be added to the Author tool 40. The skill Reading Comprehension is defined in the Author tool 40 as:
The ability to digest, assimilate, understand, and distinguish the important points and facts; and the ability to identify any unresolved issues that are raised. Comprehension includes knowledge or the ability to recall previously learned material; and demonstrating an understanding of the meaning of facts by explaining, interpreting and translating. The key is to recall and explain facts, principles, and steps in sequence.

The skill Critical/Analytical Thinking is defined in the Author tool 40 as:
Reasoning in an open-ended manner, probing and peeling away layers of analysis to reveal a number of solutions, theories, and/or rationale. The analysis requires the student to break down the material into its component parts to understand the organizational structure, distinguish characteristics, and showing the relationships. The key is to separate information into component parts to understand the organizational structure, distinguish characteristics, and show the relationships

The skill Applied Reasoning is defined in the Author tool 40 as:
The definition of “Applied Reasoning” is reasoning that builds upon the basic principles and relevant facts in case studies or problems, which can be subsequently applied in a new or practical situation to develop solutions and alternatives. Applied reasoning focuses on the ability to use learned material in new and concrete situations by using concepts, principles, rules, theories and laws to find solutions to new problems. The key is transfer of knowledge.

The skill Creative Problem Solving is defined in the Author tool 40 as:
A step-by-step process of defining the problem, searching for information, testing hypotheses with the understanding that there are a limited number of solutions. Creative problem solving involves a synthesis of parts to form a new whole; and evaluation to judge the value of the material provided for a specific purpose using defined criteria. The keys are to combine parts and make judgments.

The four predefined skills are hierarchical in structure, where the skill of Reading Comprehension is part of the skill Critical/Analytical Thinking. The skill Critical/Analytical Thinking is part of the skill Applied Reasoning. In turn, the skill Applied Reasoning is part of the skill Creative Problem Solving. Therefore, mastering the skill of Creative Problem Solving requires mastering the skill of Applied Reasoning. Mastering the skill of Applied Reasoning requires mastering the skill of Critical/Analytical Thinking. And mastering the skill of Critical/Analytical thinking requires mastering the skill of Reading Comprehension.

The Questions Wizard 46

After a module, a part, and a lesson have been created for a course 65, questions can be created for a lesson. An instructor can manually create questions by stepping through different question fields and providing the information that is required by each field. Alternatively, the instructor can use a Questions Wizard 46 to assist the instructor in creating questions. The Questions Wizard 46 utilizes information stored in the data folders 71-78 as described above with reference to the Skills Wizard 42, from a skill that was previously created and saved by the Skills Wizard 42, or created manually without the Skills Wizard 42. In a preferred approach, the Questions Wizard 46 uses information from folders 71-74 of a predefined skill 43 during the creation of questions. The Questions Wizard 46 may optionally use information from folders 75-78 in guiding the Instructor through the creation of a question.

The Questions Wizard 46 utilizes information contained in the Instructions folder 74 of the chosen skill created by the Skills Wizard 42 (or alternatively by a Skill Editor) to provide instructions to the instructor to guide the instructor's generation of questions appropriate for the chosen skill. For example, depending on the question type chosen, (e.g., Multiple Choice, Multiple Choice/Multiple Answer, True/False, Matching, Short Answer, and Branching) the Questions Wizard 46 program dictates which fields are to be completed.

After the instructor has selected a skill to be tested in a lesson, in a preferred embodiment, the Questions Wizard 46 uses the category instructions (as discussed above with respect to Instructions folder 74) for each category of the skill in the Instruction folder to prompt the instructor to create questions. For example, the Reading Comprehension skill has five categories (e.g., “Points . . . ”, “Issues . . . ”, “Most important . . . ”, “Unresolved facts . . . ”, and “Case Study . . . ”). The Questions Wizard 46 displays the first category for the instructor “Identify up to four important points or issues raised in the lesson and/or case study. (State in the form of a question using the key words).” The instructor selects the type of questions and then enters data associated with the category: the question text, a correct answer, the explanation for the correct answer, incorrect answers, and the explanation for each incorrect answer. The instructor can optionally enter a fact pattern associated with the question. When the instructor is finished with entering the information for the category, the instructor can continue entering data associated with the remaining categories. For each category, the instructor can enter up to five questions.

At any point, the Instructor can cancel and close the Questions Wizard 46. The instructor can also indicate that they are done with questions, and the Questions Wizard 46 saves the questions as part of the lesson and close the Questions Wizard 46 display screen. The instructor can also indicate “next” and the Questions Wizard 46 provides the next category as an instruction, if any categories have not yet been responded to. When the instructor is done with questions, the information provided in the fields is formatted to become questions that can be modified or changed from the Questions folder 77.

When the questions are completed, if an instructor desires, the questions are accessible from the Instructor's website as part of the course or can be exported into a MS Word or Excel document and used in another content delivery system. For example, the content is preferably usable by any Microsoft Office program or any program that can access data formatted for Microsoft Office. It is possible to use other word processing programs.

When an instructor has completed the questions corresponding to a skill, the Instructor is returned to the questions menu in author 40. After returning to the author 40 screen, an instructor can continue to modify data in the course's modules, parts, lessons, and questions. In addition to using a Questions Wizard 46 to add questions, a Instructor can manually add, modify, or delete question using a Questions Editor.

In the exemplary embodiment, a questions in a course 65 can have several different variations as noted above and below. Additionally, an instructor can assign parameters to the question that can be used for assessment purposes, such as a number of points for correctly answering the question on the first try and lesser points for subsequent attempts to answer the question correctly, where the lesser the number of points decreases until an answer will have no points assigned. The instructor can also indicate the maximum time for a student to answer the question for which points can be allocated. Furthermore, the instructor can provide hints and help with the logic of the question to answer the question.

During a user's execution of a course 65 (FIG. 2), in a preferred approach, a user will be guided sequentially through course 65, although the invention is not necessarily so limited. For example, the course will begin with module1 and display any information associated with that module. The course 65 sequence will then continue to part1 and display any information associated with that part. The course 65 sequence will then continue to lesson1 and display any information associated with that lesson. The course 65 sequence will then continue to questions, display any information associated with that question, wait for and store information provided by the user in response to that question. The course 65 will then continue to question2. The course 65 will proceed guiding the user through the remainder of the modules, parts, lessons, and questions, until either the user stops (or pauses) the course 65, or until the last of the modules, parts, lessons, or questions has been completed by the user.

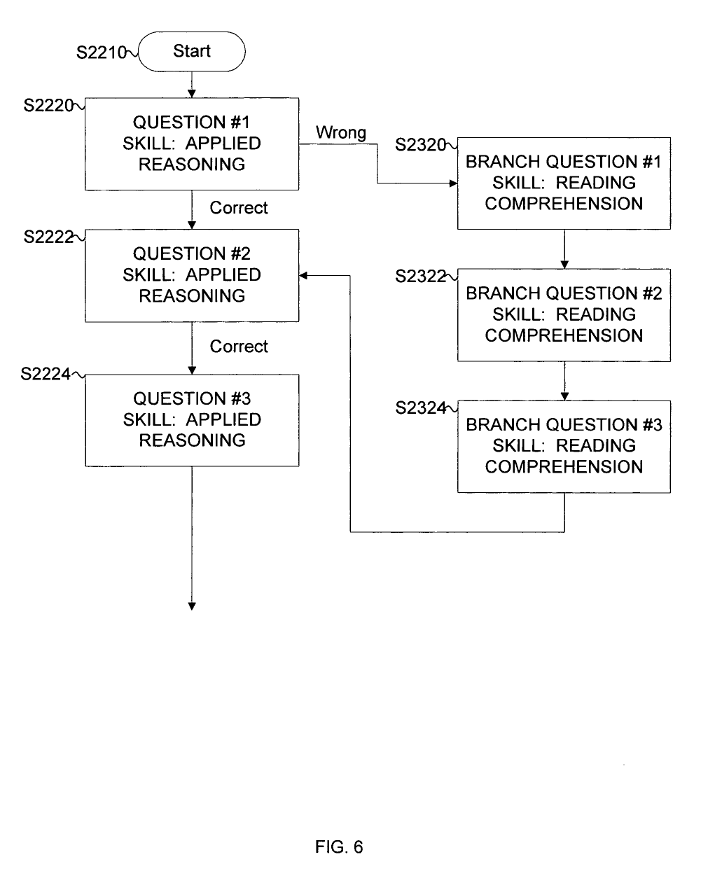

In another aspect of the invention, the logical flow of the questions is adaptive and can be modified depending on the response of a student to a question. FIG. 6 depicts an exemplary question flow when creating questions for a course 65. In this exemplary approach, the instructor has defined a question #1 which is of the skill type Applied Reasoning. As part of an intuitive feedback aspect of the invention, the instructor has decided that if a student gets the answer to question #1 incorrect, that it is important to follow up to assess why the student got the question incorrect, or alternatively, to determine if the student may need to approach the subject matter of question #1 from a different perspective. As such, the instructor has created a “branch” from question #1 if the response to the question is incorrect. That branch changes the flow of the program to now address a different question to follow question #1. Thus, if the student's response to question #1 was correct, then the program sequence would flow to question #2. If the student's response to question #1 was incorrect, then the program sequence would flow to branch question #1. Branch question #1 can be of the same or different skill than question #1.

For example, question #1 can be an Applied Reasoning skill and branch question #1 can be a Reading Comprehension Skill or some lesser order skill Branch question #1 can also be of the same or different question type than question #1. For example, question #1 can be a true/false type of question and branch question #1 can be a short essay answer type of question. Questions that branch from a question can lead back to an original flow of the questions in the course or to other progression of question. For example, as seen in FIG. 6, if at program sequence S2220 a student answers question #1 incorrectly, the program sequence flows to sequences S2320, S2322, and S2324 and then returns to question #2 for the program sequence to continue. Alternatively, the program flow in the branch off of question #1 could have branched further or ended.

Branching is an option available to an instructor when creating or modifying questions in a course. During the creation of a question, the instructor indicates if the question is a branching question. If a question is designated as a branching question, the instructor should specify the program sequence flow if the question is answered correctly and if answered incorrectly.

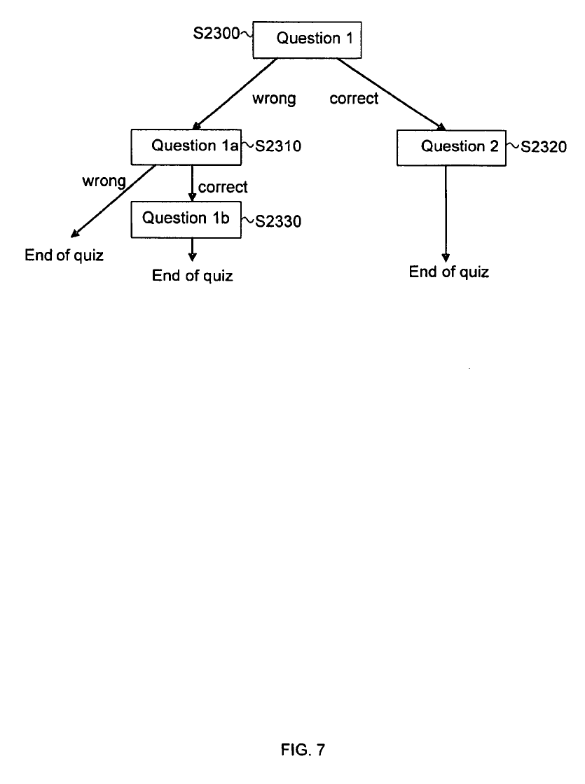

FIG. 7 is a flow chart depicting an exemplary program flow with a branching aspect. In this example, the flow shows branching of the program sequences depending on the response of the student taking the exam. For example, if the answer to segment S2300, Question 1, is incorrect, then the program sequences proceeds to segment S2310, Question 1a. If the answer to segment S2300, Question 1, is correct, then the program sequences proceeds to segment S2320, Question 2. If the answer to segment S2310, Question 1a, is incorrect, then the program sequences proceed to end. If the answer to segment S2310, Question 1a, is correct, then the program sequence proceeds to segment S2330, Question 1b.

A such, the electronic workbooks 10 help instructors focus their teaching goals and facilitates the creation of directed skills. From the skills, an instructors can then create questions more focused on the intended learning outcome.

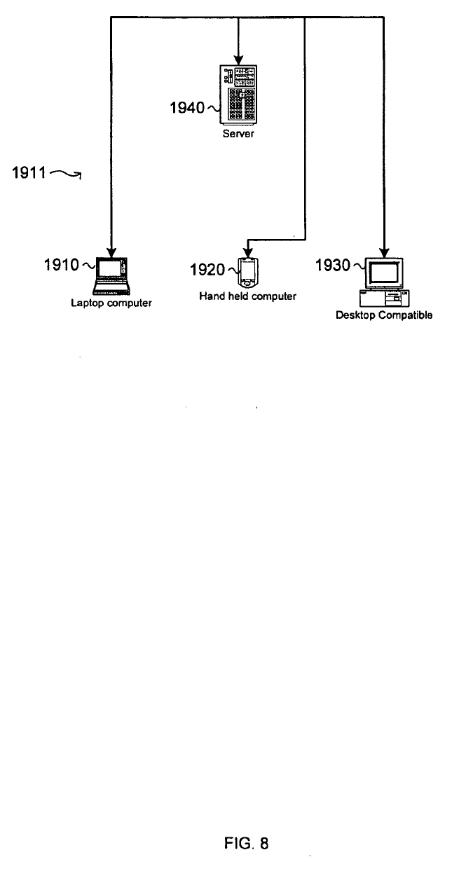

FIG. 8 depicts a electronic workbooks 10 employed in a computer network system 1911 according an exemplary embodiment of the invention. In an exemplary embodiment, a author tool 40 resides on a central server 1940 that is accessible by a network to a computer. In an embodiment, the system 10 and/or the author tool 40 resides on a platform provider's network computer system (not shown), but can be downloaded by the instructor to a hard drive on a local computer or stored on a server 1940 of a local network. The server 1940 can be, for example, a web server, and the network can be the Internet. A computer may be, for example, a laptop 1910, desktop 1930, or hand held computer 1930. In use, an administrator, instructor, or student may utilize any of the computers to access the electronic workbooks system 10 through the local network 1911 or from the platform provider's system.

In another aspect, the electronic workbooks 10 can be used on a non-networked computer, where all of the functions of electronic workbooks 10 are performed on that computer. Alternatively, the electronic workbooks 10 can be used on several non-networked computers, where some of the functions of electronic workbooks 10 are conducted on a first computer (e.g., an instructor creating a course) and other functions are conducted on second computer (e.g., a user taking a course). As is well known to those with skill in the art, different aspects of the workbooks 10 are not intended to be limited to residing on different types and configurations of computer systems.

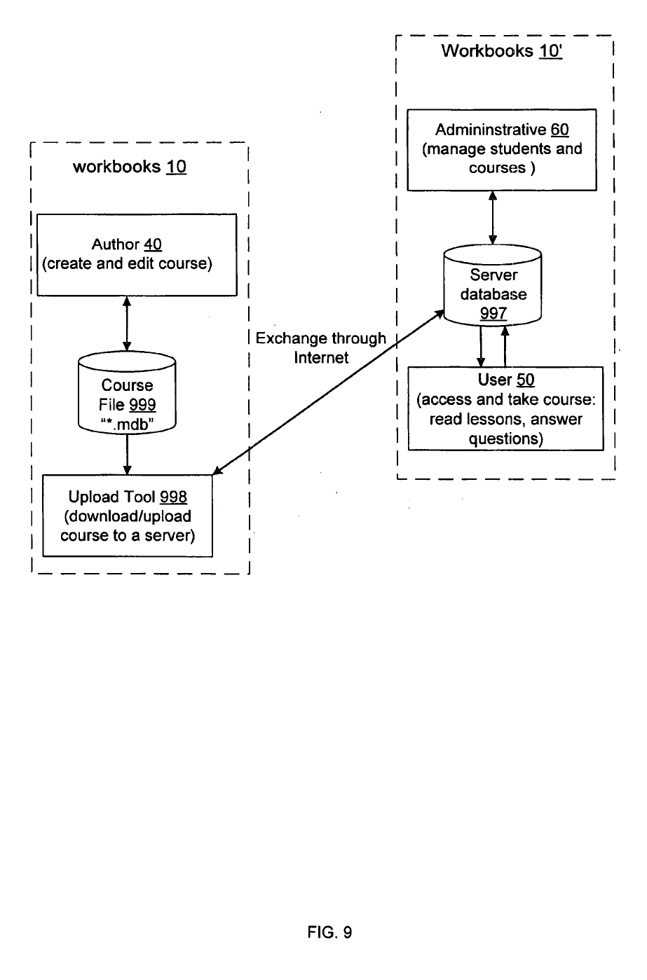

FIG. 9 depicts a electronic workbooks system 10 employed in a computer network system in another aspect of an exemplary embodiment of the invention. As seen in FIG. 9, Author 40 of the workbooks system 10 interacts with a course file database. In a preferred embodiment, a course 65 is stored in PC computer file 999 in a “*.mdb” format. After a course 65 has been created by an Instructor, a Upload Tool 998 is utilized to copy and upload the course, preferably through the Internet, to a server where the course program resides and is be run from. A second workbooks 10′ includes Administrative 60 and User 50 tools where administrators and users can access the course residing on the Server 997.

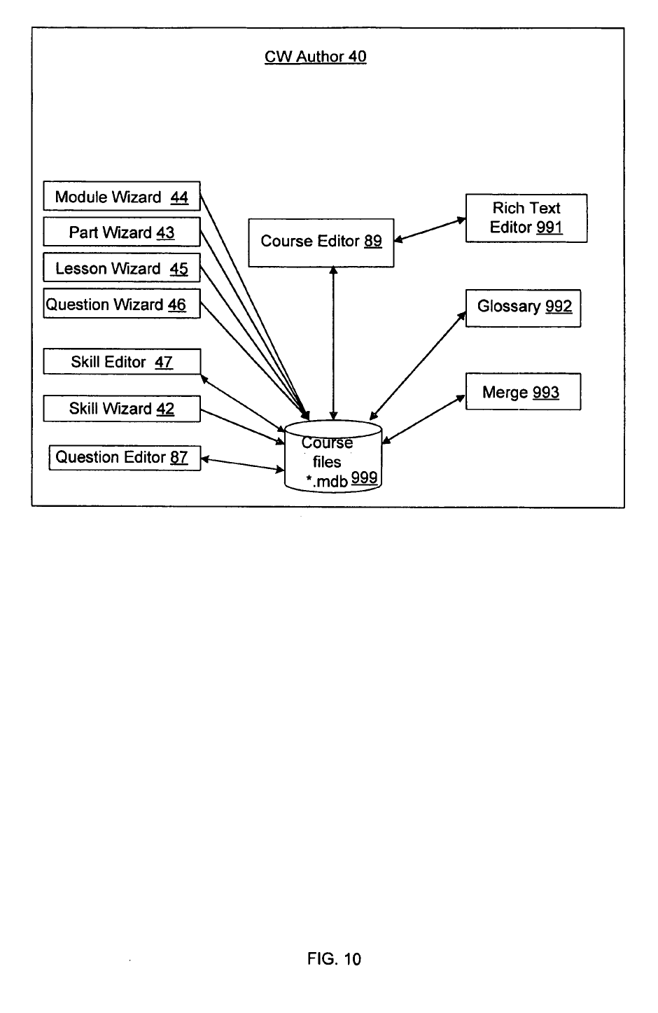

FIG. 10 depicts a logical schematic of a workbooks system 10 according to an exemplary embodiment of the invention. As seen in FIG. 10, the course files interact with different aspects of the workbooks. The Module, Part, Lesson, Question Creator, and Skills Wizard provide information to the course file database file 999. The Skills, Course, and Question (not shown) Editor as well as the Glossary and the Merge are used to manage and edit information residing in the course files.

When the course module has been completed, it must be uploaded to a central server in order for the student user to access the course module2, generally the central server is associated with the educational institution where the student attends. In an exemplary embodiment, the system 10 and/or the author tool 40 includes an Upload Tool 998 that scans the course module to determine that it is complete, i.e., all graphics and multimedia have been included and uploaded with the course module to the central server.

Once a course or a course module has been created, it can be stored for use at a later time and the content can be changed. For example, course modules, parts, lessons, and questions can be added, deleted, or modified. Furthermore, additional skills can be created and used to create questions or modify existing questions. Additionally, a course module can be merged with a new or existing course or course module; so that it is portable, and can be provided to others for use by others in other systems. For example, after an instructor at one educational institution creates a course or a course module on modem U.S. history, the instructor can provide that course module to another instructor and/or another educational institution for use. Furthermore, a course module can be collaboratively created or modified by different instructors at the same or different educational institutions.

The educational institution can be a public school, private school, or some other third party education company or publisher. In a preferred embodiment, the central server is accessible through the Internet. Central server's websites generally have security mechanisms for a student to access a course module. Thus, a student enrolled in a class is required to have a username and a password to access the course module. The program “grades” the student's answers and the results of the student's questions are stored in the website hosting the student site, in a preferred embodiment, the course module is stored in and accessed at a website of a central server. A student user of a course module may be the same educational institution or a different educational institution as the author of the course module.

Data from a student who takes a test of a course module can be saved for later use. Some of the examples of data that may be culled are the number of correct answers, the amount of time used to answer each question, the amount of time allotted by the author to answer a question, the number of times a student logs in to complete a course module, and the length of each question. Additionally, the data can be used to correlate the type of question, e.g., the type of skill tested, with the responses of the student. The data collected is not necessarily limited to a single student's data, and can include summary and comparative data of other students, classes, and instructors as well.

In a preferred embodiment, reports can be designed to generate analysis based on data collected from the course modules, including reporting on: grade reports (applying formulas and convert to different matrix, e.g. letter grades, normalized, or converted to a different point scale or percentage), proficiency with objective questions: grade based upon type of question (i.e., multiple choice, true/false, matching parts, etc.), proficiency with a skill (i.e., reading comprehension, where the skill can be organized by subject, lesson in order, and modify the type of analysis based on whether reporting diagnostic or evaluation purpose.) Reports can also be designed that reflect analysis of a skill or different aspects of a skill or skills. For example, in a situation where skills are built upon other skills, as noted above with respect to the four pre-defined skills (i.e., Creative Problem Solving, Applied Reasoning, Critical/Analytical Thinking, Reading Comprehension), an analysis of a course module can be related to the students' mastery of different skills.

An advantage of an embodiment of the invention is the ability of take the reports and provide analysis of the students' mastery of different skills. This analysis in a preferred embodiment provides feedback to a student to determine her strengths and weakness in the course. The analysis also provides feedback to an instructor to assess the effectiveness of their instruction or instructional approach; that assessment could be used by the instructor to prepare future lesson plans tailored to the strengths and weaknesses of the students in the instructor's course. As noted above, educational institutions submit their programs and courses to some form of independent accreditation body to assure students that there are minimum standards of content. In a preferred embodiment, an assessment of students performance in a course is provided to an accreditation bureau or oversight organization.

Another advantage of using the present invention is that it can guide instructors to focus their learning goals for a student early in the planning process for a class. The instructor can also identify student skills goals.

Another advantage of use of the present invention is that a student can receive a self assessment of her competency during the course, rather than having to wait until the end. In a preferred embodiment, a student uses course modules of a class during the class term, and receives feedback of her performance on the course module. As the course module is set up to identify and test different skills, the student's competency on the tested different can be provided to the student. As such, the student can utilize this assessment to guide their learning needs.

In another aspect of the invention, an exemplary method is provided for instructors and educational institutions to participate in an incentive-based, royalty-sharing program where a course creator (i.e., an author) can earn royalties for creating course modules. Furthermore, in the absence of an agreement to the contrary, the course module author can retain ownership of the content of course module even though the course module may have been created in partnership with an educational institution. Depending on the situation, there may several different parties involved in the creation of a course or a course module.

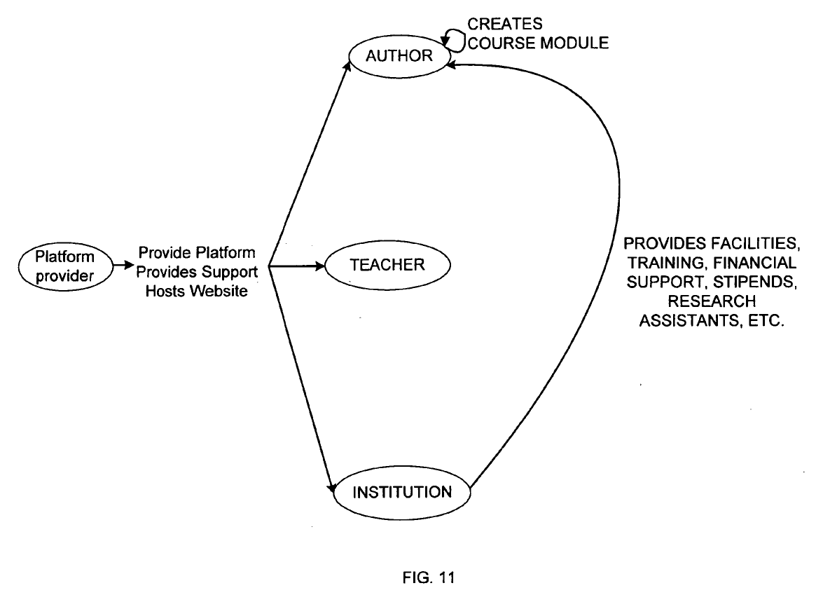

As noted above and depicted in FIG. 11, in an exemplary embodiment of the invention, there are at four parties to the revenue sharing system. A platform provider, an author, an instructor, and an educational institution. The platform provider provides the software program that enables an instructor to create and modify a course or a course module. The platform provider also provides the software that permits performing administrative aspects and allowing the student interactions with the system. The administrative aspects may include viewing student data (as noted above) and creating reports from the data.

Another party involved in the business model is the author of the course module. The author may be a single individual or a group of people. Additionally, another person may modify a previously created course module to create a derivative course module. In that case, there are several authors of the derivative course module. This aspect does not apply to publishers or third parties who already have contractual relationships with the author, and those who want to convert the entire or part of text version of a published course textbook into a series of course modules. Another party to the business transaction is a instructor who utilizes a previously created course module as part of their course. The instructor also accesses the administrative features of the electronic workbooks. This aspect does not apply to publishers or third parties who already have contractual relationships with the author, or who want to convert the entire or part of a text version of a published course textbook into a series of course modules. In an aspect of the invention, the author and the instructor are the same person. A fourth party to the business model is an educational institution where the author works, typically a public or private educational institution of any level, including K-12, secondary, post-secondary, graduate, and continuing education This aspect does not apply to publishers who already have contractual relationships with the author, or who want to convert the entire or a part of a published text version of a course textbook into a series of course modules.

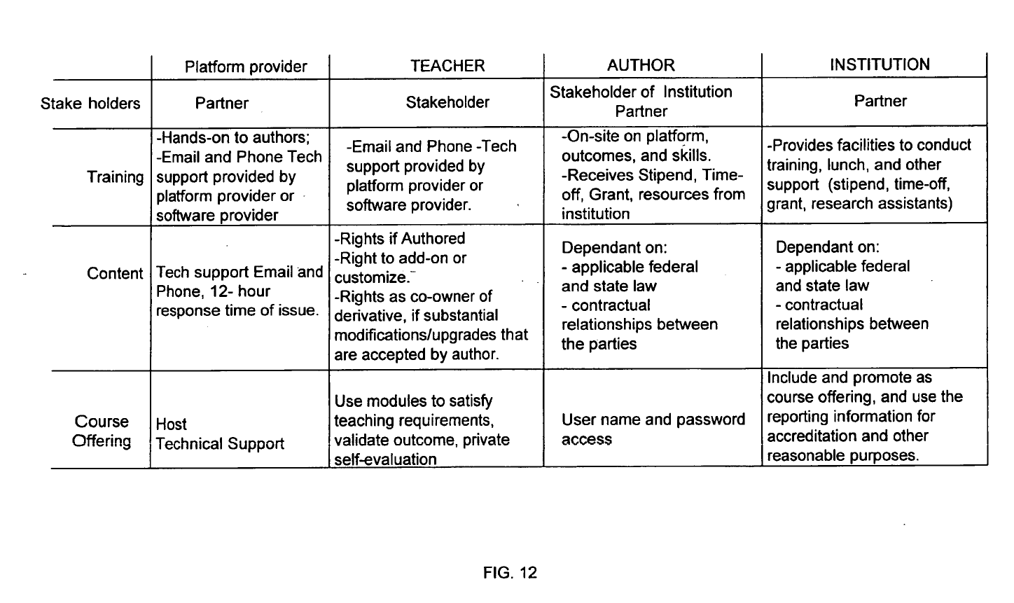

FIG. 12 is a table depicting the sharing of intellectual property rights according to an exemplary embodiment of the invention. As depicted in the FIG. 12, each of the parties (i.e., author, platform provider, educational institution, and instructor,) may have a financial interest in a course or a course module. The type of educational institution hosting the system and the relationships between the parties can dictate who receives what type of incentives, thus the author's right to the content and the educational institutions right to the content are defined by examining relevant federal and state laws and the contractual obligations between the parties. See, for example, “Reconciling Copyright Ownership Policies for Faculty-Authors in Distance Education”, Andrea L. Johnson, Journal of Law and Education, October, 2004, pp. 431-455, which is incorporated by reference in its entirety. For example, a course author who works at private university and develops a course or a course module as part of her employment activities at the university may not have, by existing copyright laws, any rights in the created work, but the rights would belong to the educational institution as a work for hire. Therefore, assuming contractual and other obligations are appropriately set, in particular with the intellectual rights arising out of the creation and use of a course or a course module, an instructor can receive a royalty stream of revenue for the use of a course module created by the author.

In a preferred embodiment of the invention, the platform provider and the educational institution enter into an agreement that provides royalty rights to the author for the use of a course or a course module created by the author. The agreement between the educational institution and instructor includes terms, definitions, and provisions that delineates what constitutes an “author.” For example, if an instructor who is not the author makes any changes to the course module for individual class use, they are not automatically be deemed an author of this modified, derivative course module. There generally must be notice and agreement for co-ownership to be claimed entitling the instructor of the modified course module to share royalties. Therefore, assuming contractual and other obligations are appropriately set, an instructor can receive a royalty stream of revenue for the use of a course module created by the author.

Additionally, an author who works in certain educational institutions, e.g., certain public school systems, may be prohibited from receiving additional income derived from developing a course module “on school time” as the author is already be paid by the school for their time. Thus, in this situation, the author would have to clearly delineate his legal rights with the educational institution prior to creating a course or a course module. Alternatively, the author may be compensated for professional development to learn how to use the authoring tool, and then create the course module on his or her own time and be entitled to royalties under a site license with the educational institution system and create the course module “on her own time.” This aspect does not apply to publishers who already have contractual relationships with the author, and those who want to convert a published text version of a course textbook into a series of course modules.

In a preferred embodiment, the author of the course module would receive a royalty based on the license fee. A license fee is based on how the course module is anticipated to be used and is predetermined up front not to exceed the average cost of a quiz, textbook supplement, or textbook. In a exemplary embodiment, a total of twenty percent (20%) of the license fee is paid to the author(s) and twenty percent (20%) to the educational institution is paid as an administrative fee, if they host the platform. The percentage may be adjusted as costs change or by agreement between the parties.

In the preferred embodiment, the author would receive twenty percent (20%) of the license fee, or a percentage of student fees received (e.g., student course fees) by the educational institution. Additionally, the author may receive fees from other educational institutions and/or authors that use or modify the author's course module. Additionally, an author may receive incentives from the educational institution in the form of research assistance, time-off, stipends, or grants, to create a course module and encourage the use of the course module. The percentage may be adjusted as costs change or by agreement between the parties.

In a preferred embodiment, an educational institution receives fees from students to use a course module, e.g., a license fee, thus the educational institution receives a cash flow from the student's use of the course module. Additionally in another aspect, the educational institution uses data collected from the students' responses for accreditation or for other reporting purposes. Thus, in accordance with the exemplary embodiment is provided a web-based course development platform that includes an authoring tool with built-in assessment features that employ a series of wizards to identify, track, measure, and report on learning outcomes and identify student weaknesses, without any special training. Additionally, the educational institution may use data culled from the student's responses to use for accreditation or for other reporting purposes.

In an exemplary embodiment, the system is first installed or made available to the educational institution. A site registration fee is paid to the platform provider that is tied to the number of total student users. The educational institution shall pay the platform provider, an annual registration upon execution of a site license that will be adjusted from time to time as costs change.

Although certain licensing agreements are discussed above, other licensing arrangements are possible and are not meant to limit the scope of the invention.

Thus, in accordance with the exemplary embodiment is provided a web-based course development platform that includes an authoring tool with built-in assessment features that employ a series of wizards to identify, track, measure, and report on learning outcomes and identify student weaknesses, without any special training. The platform enables faculty authors to work individually or collectively to create and publish a course or course modules, receive a royalty for use of the course materials, and report on student learning. Additionally, in accordance with an exemplary embodiment of the invention, a revenue-sharing system is set up whereby a course author can share.

While the invention has been described and illustrated with reference to specific exemplary embodiments, it should be understood that many modifications and substitutions could be made without departing from the spirit and scope of the invention. For example, the royalty system is not limited to any particular copyrightable or patentable work. Accordingly, the invention is not to be considered as limited by the foregoing description but is only limited by the scope of the claims.

What is claimed as new and desired to be protected by Letters Patent of the United States is:

1. A system for creating instructional material, comprising:
a skills authoring tool, the skills authoring tool operable to:
prompt a user to input a plurality of components of a skill, and
accept said plurality of components.

2. The system of claim 1, wherein said skills authoring tool further operable to:
save said plurality of components as part of said skill.

3. The system of claim 2, further comprising:
a questions authoring tool,
wherein the skills authoring tool is further operable to select a saved skill to be used to be used with said questions authoring tool, and
wherein said questions authoring tool is operable to prompt a second user, based on information from said saved skill, to create a question.

4. The system of claim 3, wherein said questions authoring tool is further operable to prompt said second user, using said plurality of components of said skill, to create a question.

5. The system of claim 2, wherein said skills authoring tool is further operable to:
prompt a user to input useful words of said skill, and
accept said useful words.

6. The system of claim 5, wherein said skills authoring tool is further operable to:
prompt a user to input instructions of said skill, and
accept said instructions.

7. The system of claim 6, wherein said skills authoring tool is further operable to:
prompt a user to input a purpose of lesson of said skill, and
accept said purpose of lesson.

8. The system of claim 7, wherein said skills authoring tool is further operable to:
prompt a user to input a purpose of questions of said skill, and
accept said purpose of questions.

9. The system of claim 8, wherein said skills authoring tool is further operable to:
prompt a user to input types of questions of said skill, and
accept said types of questions.

10. The system of claim 9, wherein said skills authoring tool is further operable to:
prompt a user to input a difficulty of questions of said skill, and
accept said difficulty of questions.

11. A system for creating instructional material, comprising:
a questions authoring tool, the questions authoring tool operable to:
select a saved skill to be used to be used with said questions authoring tool, and
prompt a first user based on information from said saved skill to create a question.

12. The system of claim 11, wherein said saved skill was created by a second user, where second user is different from said first user.

13. The system of claim 12, wherein said questions authoring tool is further operable to:
prompt the user for a question based on a category of said saved skill, and
accept said question.

14. The system of claim 13, wherein said questions authoring tool is further operable to:
use category instructions from said saved skill when prompting the user for a question based on a category of said saved skill.

15. The system of claim 11, further comprising:
a administrative tool, and
a skills authoring tool.

16. A method for creating instructional material comprising:
prompting a user to input a plurality of components of a skill, and
accepting said plurality of components.

17. The method of claim 16, further comprising saving said plurality of components as part of said skill.

18. The method of claim 17, further comprising:
selecting a saved skill to be used to be used with a questions authoring tool; and
prompting a second user based on information from said saved skill to create a question.

19. The method of claim 18, further comprising prompting said second user using said plurality of components of said skill to create a question.

20. The method of claim 17, further comprising:
prompting a user to input useful words of said skill; and
accepting said useful words.

21. The method of claim 20, further comprising:
prompting a user to input instructions of said skill; and
accepting said instructions.

22. The method of claim 21, further comprising:
prompting a user to input a purpose of lesson of said skill; and
accepting said purpose of lesson.

23. The method of claim 22, further comprising:
prompting a user to input a purpose of questions of said skill; and
accepting said purpose of questions.

24. The method of claim 23, further comprising:
prompting a user to input types of questions of said skill; and
accepting said types of questions.

25. The method of claim 24, further comprising:
prompting a user to input a difficulty of questions of said skill; and
accepting said difficulty of questions.

26. A method for creating instructional material comprising:
selecting a saved skill to be used to be used with a questions authoring tool, and
prompting a first user based on information from said saved skill to create a question.

27. The method of claim 26, wherein said saved skill was created by a second user, where second user is different from said first user.

28. The method of claim 27, further comprising:
prompting the user for a question based on a category of said saved skill; and
accepting said question.

29. The method of claim 28, further comprising:
using category instructions from said saved skill when prompting the user for a question based on a category of said saved skill.

30. The method of claim 26, further comprising:
a administrative tool, and
a skills authoring tool.

31. A method of sharing revenue in created course modules, comprising:
providing a plurality of pre-existing course modules;
allowing a user to create a new course module; and
providing to the user part of a fee paid for use of the course module by a second user.

32. The method of claim 31, providing to a first institution part of the fee paid for use of the course module.

33. The method of claim 32, further comprises the step of modifying the course module by a third user.

34. The method of claim 33, providing to the third user part of the fee paid for use of the course module.

35. The method of claim 34, where said third user is employed by a second institution, said first user is employed by said first institution, where said second institution is different from said first institution.

36. The method of claim 34, where said second user attends the course at a second institution, where said second institution is separate from said first institution.
